(19) United States
(12) Patent Application Publication
(10) Pub. No.: US 2026/0064452 A1
(43) Pub. Date: Mar. 5, 2026

(54) CROSS-ENVIRONMENT EXECUTION OF A FILE IN A HYBRID RUNTIME ENVIRONMENT

(71) Applicant: Microsoft Technology Licensing, LLC, Redmond, WA (US)

(72) Inventor: Angel Jesus del Espiritu Santo HERNANDEZ MATOS, Redmond, WA (US)

(21) Appl. No.: 18/826,121

(22) Filed: Sep. 5, 2024

(51) Int. Cl. G06F 9/455

(52) U.S. Cl. CPC G06F 9/45558

(57) ABSTRACT

Techniques are described herein that are capable of performing cross-environment execution of a file in a hybrid runtime environment. A first virtual machine (VM) corresponding to a first managed runtime environment (MRE) is caused to load bridging logic by loading the first VM. The bridging logic loads a second VM corresponding to a second MRE. The first VM converts a source code file, which is created from metadata associated with a file in the second MRE, into a compiled file, which corresponds to the first MRE, and exposes the compiled file as an HTTP endpoint. The first VM passes an argument, which is included in a call from the HTTP endpoint, to the second VM via the bridging logic, which causes the second VM to generate a result by executing the file using the argument. The first virtual machine provides the result to the HTTP endpoint.

### BACKGROUND

Code developers often reuse previously developed code to the extent possible when developing new code in an effort to reduce time and cost associated with developing the new code. However, if the previously developed code is associated with a runtime environment that is different from the runtime environment in which the new code is configured to run, the developers traditionally rebuild the previously developed code from scratch to provide rebuilt code that is capable of running in the runtime environment of the new code. The developers then incorporate the rebuilt code into the new code by porting the rebuilt code into the runtime environment of the new code. Rebuilding the previously developed code and then porting the rebuilt code into the runtime environment of the new code typically consumes a substantial amount of time and resources and increases the cost of developing the new code.

### SUMMARY

It may be desirable to run previously developed code, which is configured to run in a particular runtime environment, from a different runtime environment without a need to rebuild the previously developed code and without a need to port the resulting rebuilt code from the particular runtime environment into the different runtime environment. For instance, a first virtual machine in the different runtime environment may run the previously developed code in a second virtual machine in the particular runtime environment by wrapping a source code file, which is based on metadata associated with the previously developed code, in a wrapper to provide a compiled file that is exposed as a hypertext transfer protocol (HTTP) endpoint. When an argument is received at the HTTP endpoint, the argument is passed to the second virtual machine, which enables the second virtual machine to generate a result by executing the previously developed code using the argument. The result is passed from the second virtual machine to the first virtual machine, which passes the result to the HTTP endpoint. By enabling the first virtual machine to run the previously developed code in the second virtual machine in this manner, an amount of time and resources that is consumed to develop new code, which utilizes functionality of the previously developed code, and a cost of developing the new code may be reduced.

Various approaches are described herein for, among other things, performing cross-environment execution of a file in a hybrid runtime environment using compilation of a source code file that is created from metadata associated with the file. Cross-environment execution of a file is execution of the file from a runtime environment that is different from a runtime environment in which the file is configured to run. For example, the file may be runtime environment-specific, meaning that the file has a configuration that is specific to a particular runtime environment. For instance, the cross-file execution of the file may involve a first virtual machine, which is associated with the first runtime environment, executing the file on a second virtual machine, which is associated with the second runtime environment.

A hybrid runtime environment is a runtime environment that includes multiple managed runtime environments. A managed runtime environment is a runtime environment that hosts a virtual machine (e.g., a runtime engine), which is configured to execute code. Code that is executed by the virtual machine in the managed runtime environment is referred to as “managed code.” Managed code may be written in any of a variety of computer programming languages, including but not limited to a Rust® language, a Java® language, a C#® language, and a.Net® language. A managed runtime environment is distinguished from a native runtime environment. A native runtime environment is a runtime environment that executes code directly on hardware (e.g., a processor system) of a physical computing device (e.g., a physical computer). Code that is executed by the native runtime environment on the hardware of the physical computing device is referred to as “native code.” Native code may be written in any of a variety of computer programming languages, including but not limited to a C++® language and a C™ language.

In an example approach, a first virtual machine corresponding to a first managed runtime environment is caused to load bridging logic by loading the first virtual machine. The bridging logic loads a second virtual machine corresponding to a second managed runtime environment. The first virtual machine converts a source code file, which is created from metadata associated with a file in the second managed runtime environment, into a compiled file, which corresponds to the first managed runtime environment, by compiling the source code file. The first virtual machine exposes the compiled file as an HTTP endpoint. The first virtual machine executes the file on the second virtual machine by passing an argument, which is included in a call from the HTTP endpoint, to the second virtual machine via the bridging logic, which causes the second virtual machine to generate a result by executing the file using the argument. The result, which is received from the second virtual machine via the bridging logic, is provided by the first virtual machine to the HTTP endpoint.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Moreover, it is noted that the invention is not limited to the specific embodiments described in the Detailed Description and/or other sections of this document. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form part of the specification, illustrate embodiments of the present invention and, together with the description, further serve to explain the principles involved and to enable a person skilled in the relevant art(s) to make and use the disclosed technologies.

FIG. 1 is a block diagram of an example hybrid runtime environment system in accordance with an embodiment.

FIG. 2 is an example activity diagram for performing cross-environment execution of a file in a hybrid runtime environment using compilation of a source code file that is created from metadata associated with the file in accordance with an embodiment.

FIG. 3 depicts a flowchart of an example method for performing cross-environment execution of a file in a hybrid runtime environment using compilation of a source code file that is created from metadata associated with the file in accordance with an embodiment.

FIG. 4 is a block diagram of an example computing system in accordance with an embodiment.

FIG. 5 is a system diagram of an example mobile device in accordance with an embodiment.

FIG. 6 depicts an example computer in which embodiments may be implemented.

The features and advantages of the disclosed technologies will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION

### I. Example Embodiments

It may be desirable to run previously developed code, which is configured to run in a particular runtime environment, from a different runtime environment without a need to rebuild the previously developed code and without a need to port the resulting rebuilt code from the particular runtime environment into the different runtime environment. For instance, a first virtual machine in the different runtime environment may run the previously developed code in a second virtual machine in the particular runtime environment by wrapping a source code file, which is based on metadata associated with the previously developed code, in a wrapper to provide a compiled file that is exposed as a hypertext transfer protocol (HTTP) endpoint. When an argument is received at the HTTP endpoint, the argument is passed to the second virtual machine, which enables the second virtual machine to generate a result by executing the previously developed code using the argument. The result is passed from the second virtual machine to the first virtual machine, which passes the result to the HTTP endpoint. By enabling the first virtual machine to run the previously developed code in the second virtual machine in this manner, an amount of time and resources that is consumed to develop new code, which utilizes functionality of the previously developed code, and a cost of developing the new code may be reduced.

Example embodiments described herein are capable of performing cross-environment execution of a file in a hybrid runtime environment using compilation of a source code file that is created from metadata associated with the file. Cross-environment execution of a file is execution of the file from a runtime environment that is different from a runtime environment in which the file is configured to run. For example, the file may be runtime environment-specific, meaning that the file has a configuration that is specific to a particular runtime environment. For instance, the cross-file execution of the file may involve a first virtual machine, which is associated with the first runtime environment, executing the file on a second virtual machine, which is associated with the second runtime environment.

A hybrid runtime environment is a runtime environment that includes multiple managed runtime environments. A managed runtime environment is a runtime environment that hosts a virtual machine (e.g., a runtime engine), which is configured to execute code. Code that is executed by the virtual machine in the managed runtime environment is referred to as “managed code.” Managed code may be written in any of a variety of computer programming languages, including but not limited to a Rust® language, a Java® language, a C#® language, and a.Net® language. A managed runtime environment is distinguished from a native runtime environment. A native runtime environment is a runtime environment that executes code directly on hardware (e.g., a processor system) of a physical computing device (e.g., a physical computer). Code that is executed by the native runtime environment on the hardware of the physical computing device is referred to as “native code.” Native code may be written in any of a variety of computer programming languages, including but not limited to a C++® language and a C™ language.

Example techniques described herein have a variety of benefits as compared to conventional techniques for developing code. For instance, the example techniques are capable of executing previously developed code, which is configured to run in a particular runtime environment, from a different runtime environment without a need to rebuild the previously developed code and without a need to port the resulting rebuilt code from the particular runtime environment into the different runtime environment. For example, a first virtual machine that is hosted by a first managed runtime environment is able to execute the previously developed code on (e.g., in) a second virtual machine that is hosted by a second managed runtime environment, which differs from the first managed runtime environment. In accordance with this example, the first virtual machine is able to execute the previously developed code on the second virtual machine even if the previously developed code is incapable of being executed in the first managed runtime environment. For instance, a configuration of the previously developed code may prevent the previously developed code from being executed in the first runtime environment. Accordingly, the configuration of the previously developed code may be incompatible with the first managed runtime environment. Consequently, the first virtual machine may be incapable of interpreting the previously developed code based on the configuration of the previously developed code.

The example techniques are capable of reducing an amount of time and/or resources (e.g., processor cycles, memory, network bandwidth) that is consumed to develop code. By performing cross-environment execution of a file in a hybrid runtime environment using compilation of a source code file that is created from metadata associated with the file, an amount of time and/or resources that otherwise would have been consumed to incorporate functionality of the file into code that is under development may be reduced (e.g., eliminated). For example, causing a first virtual machine corresponding to a first managed runtime environment to load bridging logic, which loads a second virtual machine corresponding to a second managed runtime environment; converting a source code file, which is created from metadata associated with a file in the second managed runtime environment, into a compiled file; exposing the compiled file as an HTTP endpoint; executing the file on the second virtual machine by passing an argument, which is included in a call from the HTTP endpoint, to the second virtual machine via the bridging logic; and/or providing a result, which results from the second virtual machine executing the file using the argument, via the bridging logic to the HTTP endpoint may reduce the amount of time and/or resources that otherwise would have been consumed to incorporate the functionality of the file into the code under development. In an aspect, operations that otherwise would have been performed to incorporate the functionality of the file into the code under development are avoided.

By reducing the amount of time and/or resources that otherwise would have been consumed to incorporate the functionality of the file into the code under development, the amount of time and/or resources that is consumed to develop the code may be reduced. In an aspect, a number of operations that are performed to develop the code may be reduced. By reducing the amount of time and/or resources that is consumed by a computing system to develop the code, the efficiency of the computing system may be increased.

By reducing the amount of time that is consumed to develop the code, the example techniques may increase a user experience and/or efficiency of a code developer who develops the code. For instance, performing the cross-environment execution of the file in the hybrid runtime environment using the compilation of the source code file that is created from the metadata associated with the file may increase the user experience and/or the efficiency of the code developer.

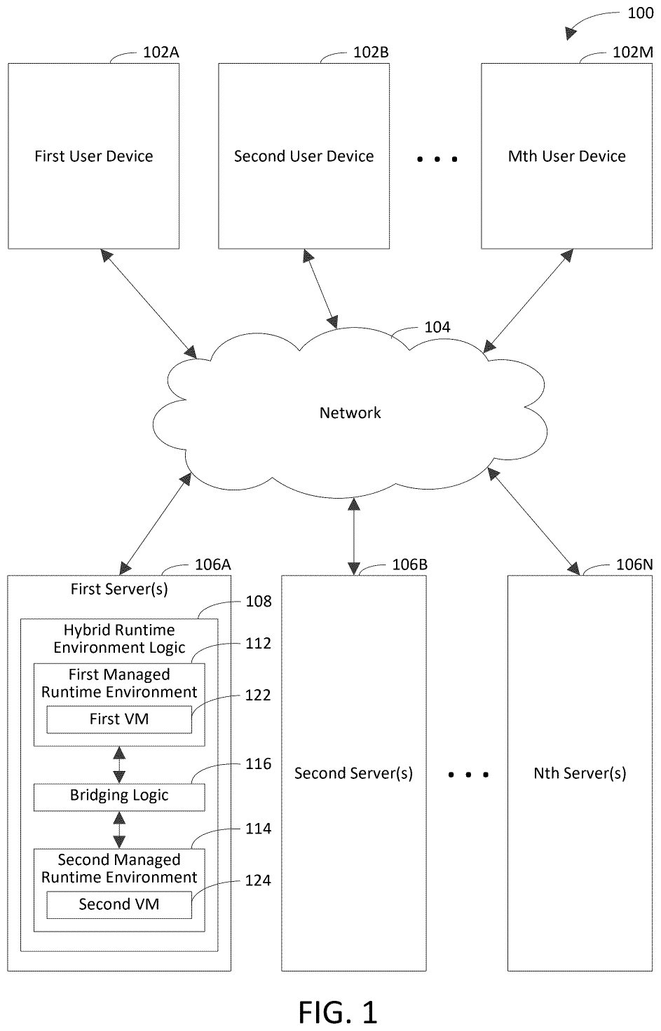

FIG. 1 is a block diagram of an example hybrid runtime environment system 100 in accordance with an embodiment. Generally speaking, the hybrid runtime environment system 100 operates to provide information to users in response to requests (e.g., hypertext transfer protocol (HTTP) requests) that are received from the users. The information may include documents (Web pages, images, audio files, video files, etc.), output of executables, and/or any other suitable type of information. In accordance with example embodiments described herein, the hybrid runtime environment system 100 performs cross-environment execution of a file in a hybrid runtime environment using compilation of a source code file that is created from metadata associated with the file. Detail regarding techniques for performing cross-environment execution of a file in a hybrid runtime environment using compilation of a source code file that is created from metadata associated with the file is provided in the following discussion.

As shown in FIG. 1, the hybrid runtime environment system 100 includes a plurality of user devices 102A-102M, a network 104, and a plurality of servers 106A-106N. Communication among the user devices 102A-102M and the servers 106A-106N is carried out over the network 104 using well-known network communication protocols. The network 104 may be a wide-area network (e.g., the Internet), a local area network (LAN), another type of network, or a combination thereof.

The user devices 102A-102M are computing systems that are capable of communicating with servers 106A-106N. A computing system is a system that includes at least a portion of a processor system such that the portion of the processor system includes at least one processor that is capable of manipulating data in accordance with a set of instructions. A processor system includes one or more processors, which may be on a same (e.g., single) device or distributed among multiple (e.g., separate) devices. For instance, a computing system may be a computer, a personal digital assistant, etc. The user devices 102A-102M are configured to provide requests to the servers 106A-106N for requesting information stored on (or otherwise accessible via) the servers 106A-106N. For instance, a user may initiate a request for executing a computer program (e.g., an application) using a client (e.g., a Web browser, Web crawler, or other type of client) deployed on a user device 102 that is owned by or otherwise accessible to the user. In accordance with some example embodiments, the user devices 102A-102M are capable of accessing domains (e.g., Web sites) hosted by the servers 104A-104N, so that the user devices 102A-102M may access information that is available via the domains. Such domain may include Web pages, which may be provided as hypertext markup language (HTML) documents and objects (e.g., files) that are linked therein, for example.

Each of the user devices 102A-102M may include any client-enabled system or device, including but not limited to a desktop computer, a laptop computer, a tablet computer, a wearable computer such as a smart watch or a head-mounted computer, a personal digital assistant, a cellular telephone, an Internet of things (IOT) device, or the like. It will be recognized that any one or more of the user devices 102A-102M may communicate with any one or more of the servers 106A-106N.

The servers 106A-106N are computing systems that are capable of communicating with the user devices 102A-102M. The servers 106A-106N are configured to execute computer programs that provide information to users in response to receiving requests from the users. For example, the information may include documents (Web pages, images, audio files, video files, etc.), output of executables, or any other suitable type of information. In accordance with some example embodiments, the servers 106A-106N are configured to host respective Web sites, so that the Web sites are accessible to users of the hybrid runtime environment system 100.

One example type of computer program that may be executed by one or more of the servers 106A-106N is a developer tool. A developer tool is a computer program that performs diagnostic operations (e.g., identifying source of problem, debugging, profiling, controlling, etc.) with respect to program code. Examples of a developer tool include an integrated development environment (IDE) and a web development platform. Examples of an IDE include a Microsoft Visual Studio® IDE, developed and distributed by Microsoft Corporation; an AppCode® IDE, a PhpStorm® IDE, a Rider® IDE, a WebStorm® IDE, etc., developed and distributed by JetBrains s.r.o.; a JDeveloper® IDE, developed and distributed by Oracle International Corporation; a NetBeans® IDE, developed and distributed by Sun Microsystems, Inc.; an Eclipse™ IDE, developed and distributed by Eclipse Foundation; and an Android Studio™ IDE, developed and distributed by Google LLC and JetBrains s.r.o. Examples of a web development platform include a Windows Azure® platform, developed and distributed by Microsoft Corporation; an Amazon Web Services® platform, developed and distributed by Amazon.com, Inc.; a Google App Engine® platform, developed and distributed by Google LLC; a VMWare® platform, developed and distributed by VMWare, Inc.; and a Force.com® platform, developed and distributed by Salesforce, Inc. It will be recognized that the example techniques described herein may be implemented using a developer tool.

Another example type of a computer program that may be executed by one or more of the servers 106A-106N is a cloud computing program (a.k.a. cloud service). A cloud computing program is a computer program that provides hosted service(s) via a network (e.g., network 104). For instance, the hosted service(s) may be hosted by any one or more of the servers 106A-106N. The cloud computing program may enable users (e.g., at any of the user systems 102A-102M) to access shared resources that are stored on or are otherwise accessible to the server(s) via the network.

The cloud computing program may provide hosted service(s) according to any of a variety of service models, including but not limited to Backend as a Service (BaaS), Software as a Service (SaaS), Platform as a Service (PaaS), and Infrastructure as a Service (IaaS). BaaS enables applications (e.g., software programs) to use a BaaS provider's backend services (e.g., push notifications, integration with social networks, and cloud storage) running on a cloud infrastructure. SaaS enables a user to use a SaaS provider's applications running on a cloud infrastructure. PaaS enables a user to develop and run applications using a PaaS provider's application development environment (e.g., operating system, programming-language execution environment, database) on a cloud infrastructure. IaaS enables a user to use an laaS provider's computer infrastructure (e.g., to support an enterprise). For example, IaaS may provide to the user virtualized computing resources that utilize the laaS provider's physical computer resources.

Examples of a cloud computing program include a Google Cloud® program, developed and distributed by Google LLC; an Oracle Cloud® program, developed and distributed by Oracle Corporation; an Amazon Web Services® program, developed and distributed by Amazon.com, Inc.; a Salesforce® program, developed and distributed by Salesforce.com, Inc.; AppSource® and Azure® programs, developed and distributed by Microsoft Corporation; a GoDaddy® program, developed and distributed by GoDaddy.com LLC; and a Rackspace® program, developed and distributed by Rackspace US, Inc. It will be recognized that the example techniques described herein may be implemented using a cloud computing program. For instance, a software product (e.g., a subscription service, a non-subscription service, or a combination thereof) may include the cloud computing program, and the software product may be configured to perform the example techniques, though the scope of the example embodiments is not limited in this respect.

The first server(s) 106A are shown to include hybrid runtime environment logic 108 for illustrative purposes. The hybrid runtime environment logic 108 is configured to perform cross-environment execution of a file in a hybrid runtime environment using compilation of a source code file that is created from metadata associated with the file. The hybrid runtime environment logic 108 includes a first managed runtime environment 112, a second managed runtime environment 114, and bridging logic 116. A first virtual machine (a.k.a. first VM) 122 runs within the first managed runtime environment 112. A second virtual machine (a.k.a. second VM) 124 runs within the second managed runtime environment 114. Accordingly, it may be said that the first virtual machine 122 is a part of the first managed runtime environment 112 and the second virtual machine 124 is a part of the second managed runtime environment 114. The bridging logic 116 is coupled between the first managed runtime environment 112 and the second managed runtime environment 114. In an aspect, the bridging logic 116 serves as an intermediary between the first managed runtime environment 112 and the second managed runtime environment 114. For example, the bridging logic 116 may serve as an intermediary between the first virtual machine 122 and the second virtual machine 124. In an example implementation, by serving as an intermediary between the first managed runtime environment 112 and the second managed runtime environment 114, the bridging logic 116 passes (e.g., forwards or transfers) data and/or communications between the first managed runtime environment 112 and the second managed runtime environment 114. In another example implementation, by serving as an intermediary between the first virtual machine 122 and the second virtual machine 124, the bridging logic 116 passes data and/or communications between the first virtual machine 122 and the second virtual machine 124.

In an example implementation, the hybrid runtime environment logic 108 causes the first virtual machine 122 to load the bridging logic 116 by loading the first virtual machine 122. The bridging logic 116 loads the second virtual machine 124. The first virtual machine 122 converts a source code file, which is created from metadata associated with a file in the second managed runtime environment 114, into a compiled file, which corresponds to the first managed runtime environment 112, by compiling the source code file. The first virtual machine 122 exposes the compiled file as an HTTP endpoint. The first virtual machine 122 executes the file on the second virtual machine 124 by passing an argument, which is included in a call from the HTTP endpoint, to the second virtual machine 124 via the bridging logic 116, which causes the second virtual machine 124 to generate a result by executing the file using the argument. The first virtual machine 122 receives the result from the second virtual machine 124 via the bridging logic 116. The first virtual machine 122 provides the result to the HTTP endpoint.

The hybrid runtime environment logic 108 may be implemented in various ways to perform cross-environment execution of a file in a hybrid runtime environment using compilation of a source code file that is created from metadata associated with the file, including being implemented in hardware, software, firmware, or any combination thereof. For example, the hybrid runtime environment logic 108 may be implemented as computer program code configured to be executed in one or more processors. In another example, at least a portion of the hybrid runtime environment logic 108 may be implemented as hardware logic/electrical circuitry. For instance, at least a portion of the hybrid runtime environment logic 108 may be implemented in a field-programmable gate array (FPGA), an application-specific integrated circuit (ASIC), an application-specific standard product (ASSP), a system-on-a-chip system (SoC), a complex programmable logic device (CPLD), etc. Each SoC may include an integrated circuit chip that includes one or more of a processor (a microcontroller, microprocessor, digital signal processor (DSP), etc.), memory, one or more communication interfaces, and/or further circuits and/or embedded firmware to perform its functions.

It will be recognized that the hybrid runtime environment logic 108 may be (or may be included in) a developer tool and/or a cloud computing program, though the scope of the example embodiments is not limited in this respect.

The hybrid runtime environment logic 108 is shown to be incorporated in the first server(s) 106A for illustrative purposes and is not intended to be limiting. It will be recognized that the hybrid runtime environment logic 108 (or any portion(s) thereof) may be incorporated in any one or more of the servers 106A-106N, any one or more of the user devices 102A-102M, or any combination thereof. For example, client-side aspects of the hybrid runtime environment logic 108 may be incorporated in one or more of the user devices 102A-102M, and server-side aspects of hybrid runtime environment logic 108 may be incorporated in one or more of the servers 106A-106N.

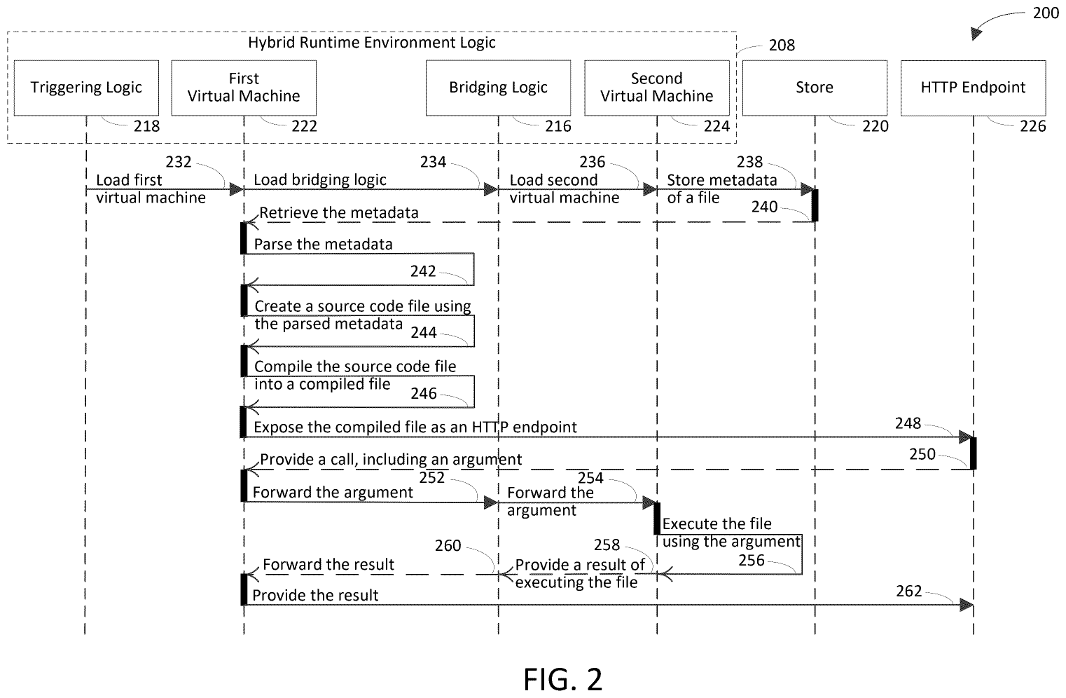

FIG. 2 is an example activity diagram 200 for performing cross-environment execution of a file in a hybrid runtime environment using compilation of a source code file that is created from metadata associated with the file in accordance with an embodiment. FIG. 2 depicts hybrid runtime environment logic 208, a store 220, and an HTTP endpoint 226. The hybrid runtime environment logic 208 includes triggering logic 218, a first virtual machine 222, bridging logic 216, and a second virtual machine 224. Activities 232, 234, 236, 238, 240, 242, 244, 246, 248, 250, 252, 254, 256, 258, 260, and 262 will now be described with reference to the triggering logic 218, the first virtual machine 222, the bridging logic 216, the second virtual machine 224, the store 220, and the HTTP endpoint 226.

In activity 232, the triggering logic 218 loads the first virtual machine 222.

In activity 234, the first virtual machine 222 loads the bridging logic 216.

In activity 236, the bridging logic 216 loads the second virtual machine 224.

In activity 238, the second virtual machine 224 stores metadata of a file in the store 220 (e.g., a cache). For instance, the metadata may be cached as character strings in the store 220. Caching the metadata as character strings may enable external clients (e.g., the first virtual machine) to invoke the file. In an aspect, the second virtual machine 224 is triggered by a triggering event to store the metadata in the store 220. For example, the triggering event may include the file being virtually dropped by a user in an interface element that represents the second virtual machine 224 or that represents a second managed runtime environment, which includes the second virtual machine 224, in a user interface. In accordance with this example, the file may be virtually dropped in the interface element using a “drag and drop” operation. A “drag and drop” operation is a pointing device gesture in which a user selects a virtual object, which is located at a first location in a user interface, by “grabbing” the virtual object and “dragging” the virtual object to a second location in the user interface. The first location and the second location are different. For instance, the virtual object may be dragged onto another virtual object at the second location. “Grabbing” the virtual object may include using a pointing device to move a pointer to the virtual object at the first location and pressing and holding a button on the pointing device while the pointer is at the first location. “Dragging” the virtual object may include moving the pointer from the first location to the second location (e.g., while the button on the pointing device is being held). The virtual object may be “dropped” at the second location by releasing the button on the pointing device.

In activity 240, the first virtual machine 222 retrieves the metadata from the store 220.

In activity 242, the first virtual machine 222 parses the metadata.

In activity 244, the first virtual machine 222 creates a source code file using the parsed metadata.

In activity 246, the first virtual machine 222 compiles the source code file into a compiled file. For example, the first virtual machine 222 may compile the source code file by wrapping the source code file in a wrapper that is compatible with a first managed runtime environment in which the first virtual machine 222 runs. For instance, compiling the source code in activity 246 may include dynamically creating proxy classes around the source code. The wrapper may define the proxy classes. The proxy class may map to classes in the source code.

In activity 248, the first virtual machine 222 exposes the compiled file as an HTTP endpoint 226. For example, the first virtual machine 222 may dynamically load the compiled file (e.g., on-the-fly) into the HTTP endpoint.

In activity 250, the HTTP endpoint 226 provides a call, which includes an argument, to the first virtual machine 222. In an aspect, the HTTP endpoint 226 is triggered by a triggering event to provide the call to the first virtual machine 222. For example, the triggering event may include an HTTP request that includes the argument being received at the HTTP endpoint 226 from a user.

In activity 252, the first virtual machine 222 forwards the argument toward the second virtual machine 224. In an aspect, the first virtual machine 222 executes the file (e.g., causes the file to be executed) on the second virtual machine 224 by forwarding the argument toward the second virtual machine 224. Because the bridging logic 216 is coupled between the first virtual machine 222 and the second virtual machine 224, the bridging logic 216 intercepts the argument that is forwarded by the first virtual machine 222. Accordingly, it can be said that the first virtual machine 222 forwards the argument to the bridging logic 216.

In activity 254, the bridging logic 216 forwards the argument that is received from the first virtual machine 222 to the second virtual machine 224.

In activity 256, the second virtual machine 224 executes the file using the argument that is received from the bridging logic 216 (i.e., received from the first virtual machine 222 via the bridging logic 216).

In activity 258, the second virtual machine 224 provides a result of executing the file toward the first virtual machine 222. Because the bridging logic 216 is coupled between the first virtual machine 222 and the second virtual machine 224, the bridging logic 216 intercepts the result that is provided by the second virtual machine 224. Accordingly, it can be said that the second virtual machine 224 provides the result to the bridging logic 216.

In activity 260, the bridging logic 216 forwards the result to the first virtual machine 222.

In activity 262, the first virtual machine 222 provides the result to the HTTP endpoint 226.

It will be recognized that the bridging logic 216 enables the first virtual machine 222 to execute the file on the second virtual machine, for example, by eliminating a need to rewrite the file (e.g., content of the file) to conform to the first managed runtime environment and/or to have a configuration that is capable of being executed on the first virtual machine (e.g., in the first managed runtime environment.

In some example embodiments, one or more of the activities 232, 234, 236, 238, 240, 242, 244, 246, 248, 250, 252, 254, 256, 258, 260, and/or 262 of the activity diagram 200 may not be performed. Moreover, activities in addition to or in lieu of the activities 232, 234, 236, 238, 240, 242, 244, 246, 248, 250, 252, 254, 256, 258, 260, and/or 262 may be performed.

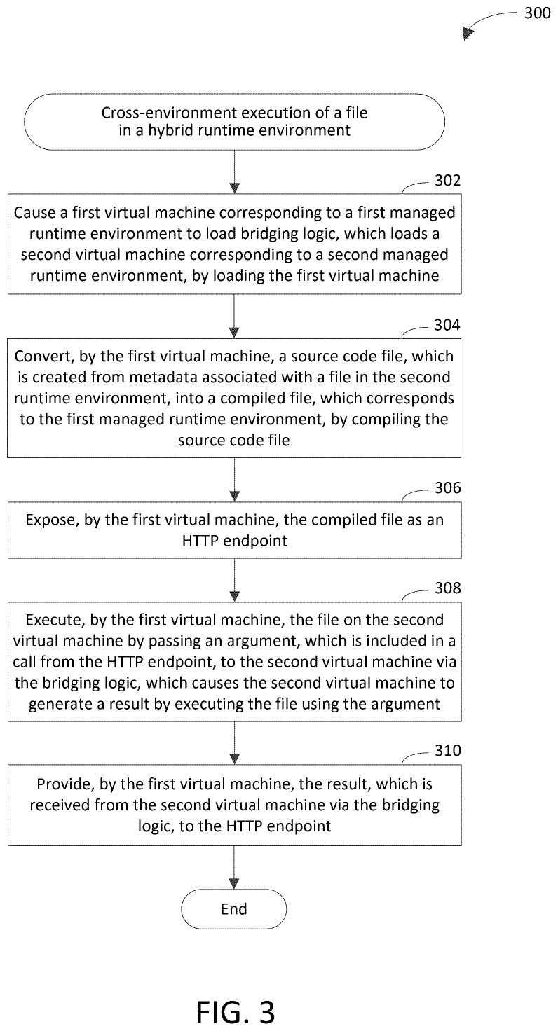

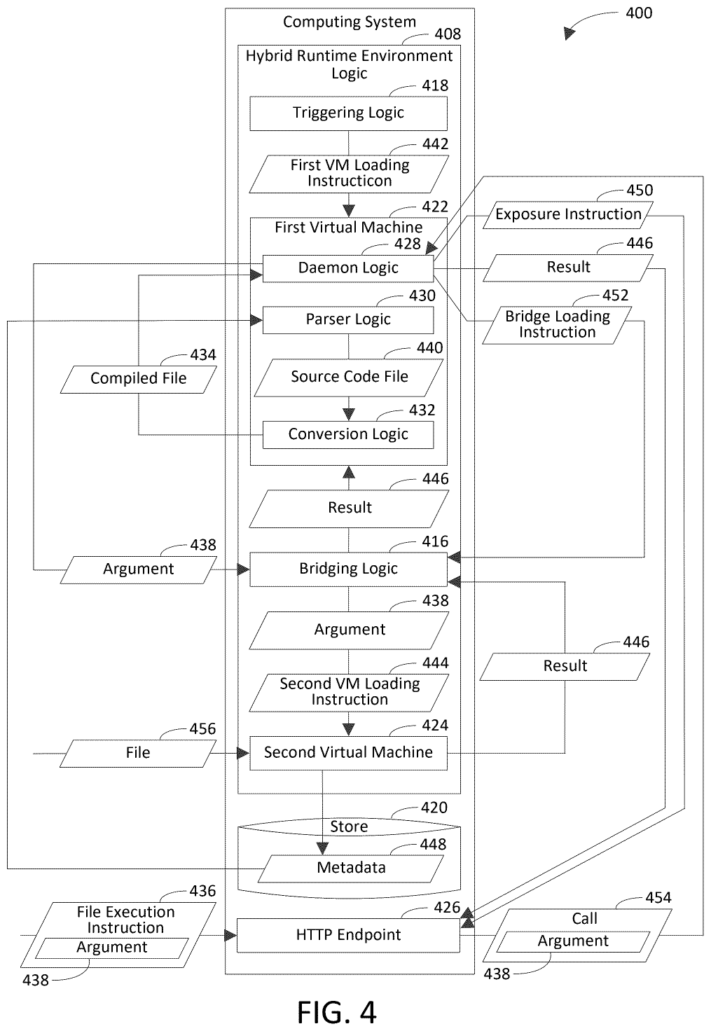

FIG. 3 depicts a flowchart 300 of an example method for performing cross-environment execution of a file in a hybrid runtime environment using compilation of a source code file that is created from metadata associated with the file in accordance with an embodiment. Flowchart 300 may be performed by the first server(s) 106A shown in FIG. 1, for example. For illustrative purposes, flowchart 300 is described with respect to a computing system 400 shown in FIG. 4, which is an example implementation of the first server(s) 106A. As shown in FIG. 4, the computing system 400 includes hybrid runtime environment logic 408, a store 420, and an HTTP endpoint 426. The hybrid runtime environment logic 408 includes triggering logic 418, a first virtual machine 422, bridging logic 416, and a second virtual machine 424. The first virtual machine 422 includes daemon logic 428, parser logic 430, and conversion logic 432. The store 420 may be any suitable type of store. One type of store is a database. For instance, the store 420 may be a relational database, an entity-relationship database, an object database, an object relational database, an extensible markup language (XML) database, etc. The store 420 is shown to store metadata 448 for non-limiting, illustrative purposes. Further structural and operational embodiments will be apparent to persons skilled in the relevant art(s) based on the discussion regarding flowchart 300.

As shown in FIG. 3, the method of flowchart 300 begins at step 302. In step 302, a first virtual machine corresponding to a first managed runtime environment is caused to load bridging logic, which loads a second virtual machine corresponding to a second managed runtime environment, by loading the first virtual machine. The second managed runtime environment is different from the first managed runtime environment. Each of the first managed runtime environment and the second managed runtime environment may be any suitable type of managed runtime environment. Examples of a managed runtime environment include a Java® Virtual Machine (JVM®) runtime environment, developed and distributed by Sun Microsystems, Inc., which has been acquired by Oracle Corporation; a Common Language Runtime™ (CLR™) runtime environment and a PowerShell® runtime environment, developed and distributed by Microsoft Corporation; an Android Runtime™ (ART™) runtime environment and a V8 Engine™ runtime environment, both developed and distributed by Google LLC; a CPython™ runtime environment, developed and distributed by Guido van Rossum and Python Software Foundation Inc.; a PyPy runtime environment, which is an open-source community effort; a Jython™ runtime environment, developed and distributed by Jim Hugunin and later maintained by the Jython project; a Node.js® runtime environment, developed and distributed by Ryan Dahl and later sponsored by Joyent, Inc.; a BEAM™ runtime environment, developed and distributed by Telefonaktiebolaget LM Ericsson (publ) for the Erlang programming language; a LuaJIT™ runtime environment, developed and distributed by Mike Pall; and a Zend® Engine runtime environment, developed and distributed by Zend Technologies Ltd. for PHP.

In an example implementation, the trigger logic 418 causes the daemon logic 428, which is included in the first virtual machine 422 corresponding to the first managed runtime environment, to load the bridging logic 416. In an aspect, the trigger logic 418 loads the first virtual machine 422, which causes (e.g., triggers) the daemon logic 428 to load the bridging logic 416. In another aspect, the daemon logic 428 loads the bridging logic 416 by executing a bridge loading instruction 452. In yet another aspect, the daemon logic 428 is an operating system service (e.g., a service that is provided by an operating system that runs on the computing system 400). The daemon logic 428 loading the bridging logic 416 causes the bridging logic 416 to load the second virtual machine 424 corresponding to the second managed runtime environment. In an aspect, the bridging logic 416 loads the second virtual machine 424 by executing a second VM loading instruction 444.

In an example embodiment, the second virtual machine is loaded by the bridging logic using a foreign function interface. A foreign function interface is a mechanism that enables a program written in a first computer programming language to call a routine (or use a service) written or compiled in a second computer programming language that is different from the first computer programming language. In an aspect, the first computer programming language corresponds to (e.g., is utilized by) the first managed runtime environment, and the second computer programming language corresponds to the second managed runtime environment. One example of a foreign function interface is Java® Native Interface (JNI™).

In another example embodiment, the second virtual machine is loaded by the bridging logic using a Java® native interface (e.g., using a software development kit (SDK) provided by the Java® native interface). In an aspect of this embodiment, the bridging logic loads the Java® native interface, and the Java® native interface loads the second virtual machine. In another aspect, the bridging logic uses the Java® native interface to natively interact with the second virtual machine. By natively interacting with the second virtual machine, it is meant that the bridging logic interacts with the second virtual machine as if the bridging logic is in the second managed runtime environment (with the second virtual machine). More particularly, by using the Java® native interface, the bridging logic appears to the second virtual machine as if the bridging logic is in the second managed runtime environment. In accordance with this embodiment, the second virtual machine is a Java® virtual machine.

In yet another example embodiment, the second virtual machine is loaded by the bridging logic in a same address space (a.k.a. memory space) in which the first virtual machine is loaded. In an aspect, the address space is a virtual address space. In another aspect, the second virtual machine is loaded by the bridging logic in a same process in which the first virtual machine is loaded. In an example implementation, the triggering logic 418 creates an application domain in which the first virtual machine 422 and the second virtual machine 424 are to be loaded. An application domain is a mechanism that isolates software application(s) that are executed in the application domain from application(s) that are executed in other application domain(s). Each application domain has its own virtual address space. In accordance with this implementation, the triggering logic 418 loads the first virtual machine 422 in the application domain, and the bridging logic 416 loads the second virtual machine 424 in the application domain.

In still another example embodiment, the bridging logic is written in native code, which is configured to run directly on a processor system that is included in the computing system. In an example implementation, the bridging logic 416 is written in native code that is configured to run directly on a processor system that is included in the computing system 400.

In another example embodiment, the bridging logic enables the first virtual machine to execute the file on the second virtual machine natively. By executing the file on the second virtual machine natively, it is meant that the bridging logic enables the first virtual machine to execute the file on the second virtual machine as if the first virtual machine is in the second managed runtime environment.

At step 304, a source code file, which is created from metadata associated with a file in the second managed runtime environment, is converted (e.g., dynamically converted), by the first virtual machine, into a compiled file, which corresponds to the first managed runtime environment, by compiling the source code file. The file may have any suitable file format, including but not limited to a Java® archive (JAR™) file format and a .NET® assembly file format. In an aspect, the compiled file is a dynamic-link library (DLL) file. In an example implementation, the conversion logic 432 converts a source code file 440, which corresponds to the second managed runtime environment, into a compiled file 434, which corresponds to the first managed runtime environment, by compiling the source code file 440. The parser logic 430 creates the source code file 440 from the metadata 448, which is associated with a file 456 in the second managed runtime environment.

In an example embodiment, converting the source code file into the compiled file at step 304 includes mapping data types, which are associated with the second managed runtime environment, in the source code file to corresponding data types, which are associated with the first managed runtime environment, in the compiled file and/or mapping functionality in the source code file to corresponding functionality in the compiled file. For instance, the data types and/or the functionality in the source code file may be indicated (e.g., specified or described) by the metadata. Example categories of data types include primitive data types, composite data types, abstract data types, and user-defined data types. Examples of a primitive data type include an integer (int), a floating-point (float, double), a character (char), and a Boolean (bool). An integer represents a whole number. A floating-point represents a number with a fractional part. A character represents a single character (e.g., a letting in an alphabet). A Boolean represents a true or false value. Examples of a composite data type include an array, a string, and a structure (struct). An array includes multiple elements of a same type. A string is a sequence of two or more characters. A structure includes multiple variables under a single name (e.g., “struct Point {int x; int y;};”). Examples of an abstract data type include a list, a queue, and a stack. A list is an ordered combination of elements. A queue is a collection configured such that elements(s) are added at the end and element(s) are removed from the front. A stack is a collection configured such that element(s) are added to the top and removed from the top. Examples of a user-defined data type include a class and an Enum. A class is a blueprint for creating objects. An Enum is a set of named constants. An example of functionality is a method.

In another example embodiment, converting the source code file into the compiled file at step 304 includes wrapping the source code file in a wrapper (a.k.a. a proxy). For example, wrapping the source code file in the wrapper may include mapping data types in the source code file to corresponding data types in the wrapper, mapping functionality in the source code file to corresponding functionality in the wrapper, and so on.

At step 306, the compiled file is exposed (e.g., dynamically exposed) as an HTTP endpoint by the first virtual machine. In an example implementation, the daemon logic 428 exposes the compiled file 434 as the HTTP endpoint 426 by executing the exposure instruction 450.

At step 308, the file is executed on the second virtual machine by the first virtual machine by passing an argument, which is included in a call from the HTTP endpoint, to the second virtual machine via the bridging logic, which causes the second virtual machine to generate a result by executing the file using the argument. In an example implementation, the daemon logic 428 executes the file 456 on the second virtual machine 424 by passing an argument 438, which is included in a call 454 from the HTTP endpoint 426, to the second virtual machine 424 via the bridging logic 416. In an aspect, the daemon logic 428 provides the argument 438 toward the second virtual machine 424, and the bridging logic 416 intercepts the argument 438 that is sent by the daemon logic 428. In accordance with this aspect, the bridging logic 416 forwards the argument 438 that is received from the daemon logic 428 to the second virtual machine 424. In this manner, the daemon logic 428 passes the argument 438 to the second virtual machine 424 via the bridging logic 416. In an aspect, the HTTP endpoint 426 receives a file execution instruction 436, which includes the argument 438. The file execution instruction 436 indicates that the file 456 is to be executed. In accordance with this aspect, the HTTP endpoint provides the call 454, which includes the argument 438, to the daemon logic 428. For example, receipt of the call 454 from the HTTP endpoint 426 by the daemon logic 428 may trigger the daemon logic 428 to pass the argument 438 to the second virtual machine 424 via the bridging logic 416. The daemon logic 428 passing the argument 438 to the second virtual machine 424 via the bridging logic 416 causes the second virtual machine 424 to generate a result 446 by executing the file 4564 using the argument 438.

At step 310, the result, which is received from the second virtual machine via the bridging logic, is provided to the HTTP endpoint by the first virtual machine. In an example implementation, the daemon logic 428 provides the result 446, which is received from the second virtual machine 424 via the bridging logic 416, to the HTTP endpoint 426. In an aspect, the second virtual machine 424 provides the result 446 toward the first virtual machine 422, and the bridging logic 416 intercepts the result that is provided by the second virtual machine 424. In accordance with this aspect, the bridging logic forwards the result 446, which is received from the second virtual machine 424, to the daemon logic 428. For example, receipt of the result 446 from the second virtual machine 424 via the bridging logic 416 by the daemon logic 428 may trigger the daemon logic 428 to provide the result 446 to the HTTP endpoint 426.

In some example embodiments, one or more steps 302, 304, 306, 308, and/or 310 of flowchart 300 may not be performed. Moreover, steps in addition to or in lieu of steps 302, 304, 306, 308, and/or 310 may be performed. For instance, in an example embodiment, the method of flowchart 300 further includes loading the first virtual machine. For example, loading the first virtual machine may cause (e.g., trigger) the first virtual machine to load the bridging logic at step 302. In an aspect of this embodiment, the first virtual machine is loaded as a .NET application. In accordance with this aspect, the first managed runtime environment is a .NET environment. In an example implementation, the trigger logic 418 loads the first virtual machine 422 by executing a first VM loading instruction 442. In accordance with this implementation, the trigger logic 418 loading the first virtual machine 422 causes the daemon logic 428 to load the bridging logic 416.

In another example embodiment, the method of flowchart 300 further includes retrieving, by the first virtual machine, the metadata from a database in which the second virtual machine stores the metadata. In an example implementation, the parser logic 430 retrieves the metadata 448 from the store 420. In accordance with this implementation, the second virtual machine 424 stores the metadata 448 in the store 420 in response to receiving the file 456. In an aspect, the second virtual machine 424 receives the metadata 448 contemporaneously with the file 456.

In yet another example embodiment, the method of flowchart 300 further includes parsing, by the first virtual machine, the metadata to provide parsed metadata. For example, the metadata may be parsed into portions corresponding to respective functionalities. In accordance with this example, a first portion of the metadata may correspond to (e.g., describe or define) a first functionality; a second portion of the metadata may correspond to a second functionality, and so on. In an example implementation, the parser logic 430 parses the metadata 448 to provide the parsed metadata. In accordance with this embodiment, the method of flowchart 300 further includes creating (e.g., dynamically creating), by the first virtual machine, the source code file using the parsed metadata. In an example implementation, the parser logic 430 creates the source code file 440 using the parsed metadata.

It will be recognized that the computing system 400 may not include one or more of the hybrid runtime environment logic 408, the bridging logic 416, the triggering logic 418, the store 420, the first virtual machine 422, the second virtual machine 424, the HTTP endpoint 426, the daemon logic 428, the parser logic 430, and/or the conversion logic 432. Furthermore, the computing system 400 may include components in addition to or in lieu of the hybrid runtime environment logic 408, the bridging logic 416, the triggering logic 418, the store 420, the first virtual machine 422, the second virtual machine 424, the HTTP endpoint 426, the daemon logic 428, the parser logic 430, and/or the conversion logic 432.

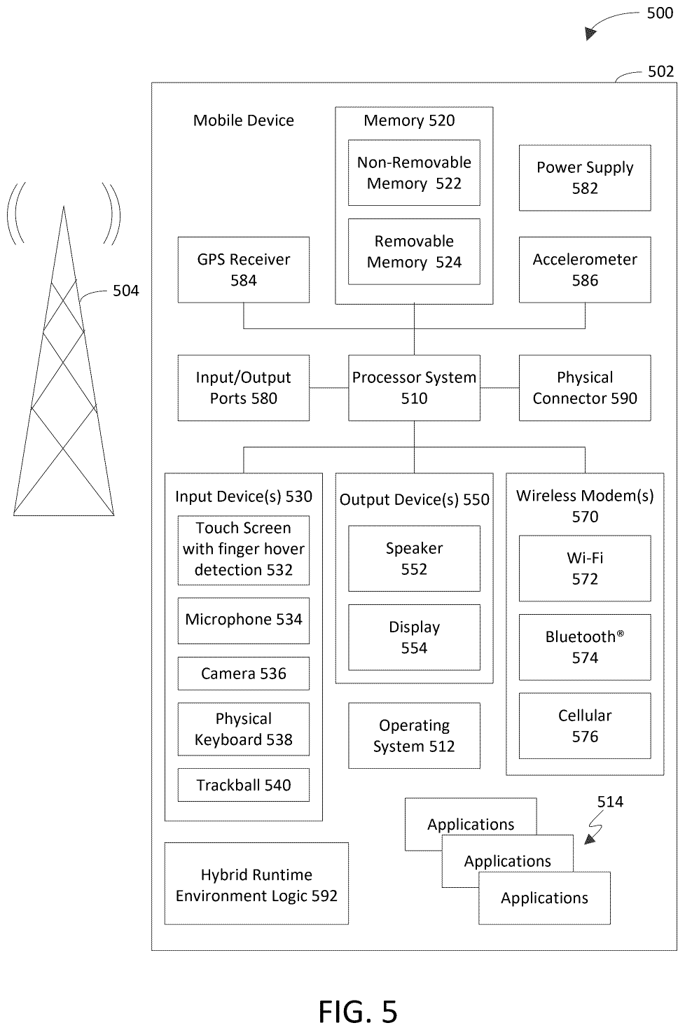

FIG. 5 is a system diagram of an example mobile device 500 including a variety of optional hardware and software components, shown generally as 502. Any components 502 in the mobile device may communicate with any other component, though not all connections are shown, for ease of illustration. The mobile device 500 may be any of a variety of computing devices (e.g., cell phone, smartphone, handheld computer, Personal Digital Assistant (PDA), etc.) and may allow wireless two-way communications with one or more mobile communications networks 504, such as a cellular or satellite network, or with a local area or wide area network.

The mobile device 500 includes a processor system 510 (e.g., signal processor, microprocessor, ASIC, or other control and processing logic circuitry) for performing such tasks as signal coding, data processing, input/output processing, power control, and/or other functions. An operating system 512 may control the allocation and usage of the components 502 and support for one or more applications 514 (a.k.a. application programs). The applications 514 may include common mobile computing applications (e.g., email applications, calendars, contact managers, web browsers, messaging applications) and any other computing applications (e.g., word processing applications, mapping applications, media player applications).

The mobile device 500 includes hybrid runtime environment logic 592, which is operable in a manner similar to the hybrid runtime environment logic 108 described above with reference to FIG. 1 and/or the hybrid runtime environment logic 408 described above with reference to FIG. 4.

The mobile device 500 includes memory 520. The memory 520 may include non-removable memory 522 and/or removable memory 524. The non-removable memory 522 may include random access memory (RAM), read-only memory (ROM), flash memory, a hard disk, or other well-known memory storage technologies. The removable memory 524 may include flash memory or a Subscriber Identity Module (SIM) card, which is well known in Global System for Mobile Communications (GSM) systems, or other well-known memory storage technologies, such as “smart cards.” The memory 520 may store data and/or code for running the operating system 512 and the applications 514. Example data may include web pages, text, images, sound files, video data, or other data sets to be sent to and/or received from one or more network servers or other devices via one or more wired or wireless networks. Memory 520 may store a subscriber identifier, such as an International Mobile Subscriber Identity (IMSI), and an equipment identifier, such as an International Mobile Equipment Identifier (IMEI). Such identifiers may be transmitted to a network server to identify users and equipment.

The mobile device 500 may support one or more input devices 530, such as a touch screen 532, microphone 534, camera 536, physical keyboard 538 and/or trackball 540 and one or more output devices 550, such as a speaker 552 and a display 554. Touch screens, such as the touch screen 532, may detect input in different ways. For example, capacitive touch screens detect touch input when an object (e.g., a fingertip) distorts or interrupts an electrical current running across the surface. As another example, touch screens may use optical sensors to detect touch input when beams from the optical sensors are interrupted. Physical contact with the surface of the screen is not necessary for input to be detected by some touch screens. For example, the touch screen 532 may support a finger hover detection using capacitive sensing, as is well understood. Other detection techniques may be used, including camera-based detection and ultrasonic-based detection. To implement a finger hover, a user's finger is typically within a predetermined spaced distance above the touch screen, such as between 0.1 to 0.25 inches, or between 0.25 inches and 0.5 inches, or between 0.5 inches and 0.75 inches, or between 0.75 inches and 1 inch, or between 1 inch and 1.5 inches, etc.

Other possible output devices (not shown) may include piezoelectric or other haptic output devices. Some devices may serve more than one input/output function. For example, touch screen 532 and display 554 may be combined in a single input/output device. The input devices 530 may include a Natural User Interface (NUI). An NUI is any interface technology that enables a user to interact with a device in a “natural” manner, free from artificial constraints imposed by input devices such as mice, keyboards, remote controls, and the like. Examples of NUI methods include those relying on speech recognition, touch and stylus recognition, gesture recognition both on screen and adjacent to the screen, air gestures, head and eye tracking, voice and speech, vision, touch, gestures, and machine intelligence. Other examples of a NUI include motion gesture detection using accelerometers/gyroscopes, facial recognition, 3D displays, head, eye, and gaze tracking, immersive augmented reality and virtual reality systems, all of which provide a more natural interface, as well as technologies for sensing brain activity using electric field sensing electrodes (EEG and related methods). Thus, in one specific example, the operating system 512 or applications 514 may include speech-recognition software as part of a voice control interface that allows a user to operate the mobile device 500 via voice commands. Furthermore, the mobile device 500 may include input devices and software that allows for user interaction via a user's spatial gestures, such as detecting and interpreting gestures to provide input to a gaming application.

Wireless modem(s) 570 may be coupled to antenna(s) (not shown) and may support two-way communications between the processor system 510 and external devices, as is well understood in the art. The modem(s) 570 are shown generically and may include a cellular modem 576 for communicating with the mobile communication network 504 and/or other radio-based modems (e.g., Bluetooth® 574 and/or Wi-Fi 572). At least one of the wireless modem(s) 570 is typically configured for communication with one or more cellular networks, such as a GSM network for data and voice communications within a single cellular network, between cellular networks, or between the mobile device and a public switched telephone network (PSTN).

The mobile device 500 may further include at least one input/output port 580, a power supply 582, a satellite navigation system receiver 584, such as a Global Positioning System (GPS) receiver, an accelerometer 586, and/or a physical connector 590, which may be a universal serial bus (USB) port, IEEE 1394 (FireWire) port, and/or RS-232 port. The illustrated components 502 are not required or all-inclusive, as any components may be deleted and other components may be added as would be recognized by one skilled in the art.

Although the operations of some of the disclosed methods are described in a particular, sequential order for convenient presentation, it should be understood that this manner of description encompasses rearrangement, unless a particular ordering is required by specific language set forth herein. For example, operations described sequentially may in some cases be rearranged or performed concurrently. Moreover, for the sake of simplicity, the attached figures may not show the various ways in which the disclosed methods may be used in conjunction with other methods.

Any one or more of the hybrid runtime environment logic 108, the hybrid runtime environment logic 208, the bridging logic 216, the triggering logic 218, the first virtual machine 222, the second virtual machine 224, the HTTP endpoint 226, the hybrid runtime environment logic 408, the hybrid runtime environment logic 408, the bridging logic 416, the triggering logic 418, the first virtual machine 422, the second virtual machine 424, the HTTP endpoint 426, the daemon logic 428, the parser logic 430, the conversion logic 432, activity diagram 200, and/or flowchart 300 may be implemented in hardware, software, firmware, or any combination thereof.

For example, any one or more of the hybrid runtime environment logic 108, the hybrid runtime environment logic 208, the bridging logic 216, the triggering logic 218, the first virtual machine 222, the second virtual machine 224, the HTTP endpoint 226, the hybrid runtime environment logic 408, the hybrid runtime environment logic 408, the bridging logic 416, the triggering logic 418, the first virtual machine 422, the second virtual machine 424, the HTTP endpoint 426, the daemon logic 428, the parser logic 430, the conversion logic 432, activity diagram 200, and/or flowchart 300 may be implemented, at least in part, as computer program code configured to be executed in one or more processors.

In another example, any one or more of the hybrid runtime environment logic 108, the hybrid runtime environment logic 208, the bridging logic 216, the triggering logic 218, the first virtual machine 222, the second virtual machine 224, the HTTP endpoint 226, the hybrid runtime environment logic 408, the hybrid runtime environment logic 408, the bridging logic 416, the triggering logic 418, the first virtual machine 422, the second virtual machine 424, the HTTP endpoint 426, the daemon logic 428, the parser logic 430, the conversion logic 432, activity diagram 200, and/or flowchart 300 may be implemented, at least in part, as hardware logic/electrical circuitry. Such hardware logic/electrical circuitry may include one or more hardware logic components. Examples of a hardware logic component include but are not limited to a field-programmable gate array (FPGA), an application-specific integrated circuit (ASIC), an application-specific standard product (ASSP), a system-on-a-chip system (SoC), a complex programmable logic device (CPLD), etc. For instance, a SoC may include an integrated circuit chip that includes one or more of a processor (e.g., a microcontroller, microprocessor, digital signal processor (DSP), etc.), memory, one or more communication interfaces, and/or further circuits and/or embedded firmware to perform its functions.

### II. Further Discussion of Some Example Embodiments

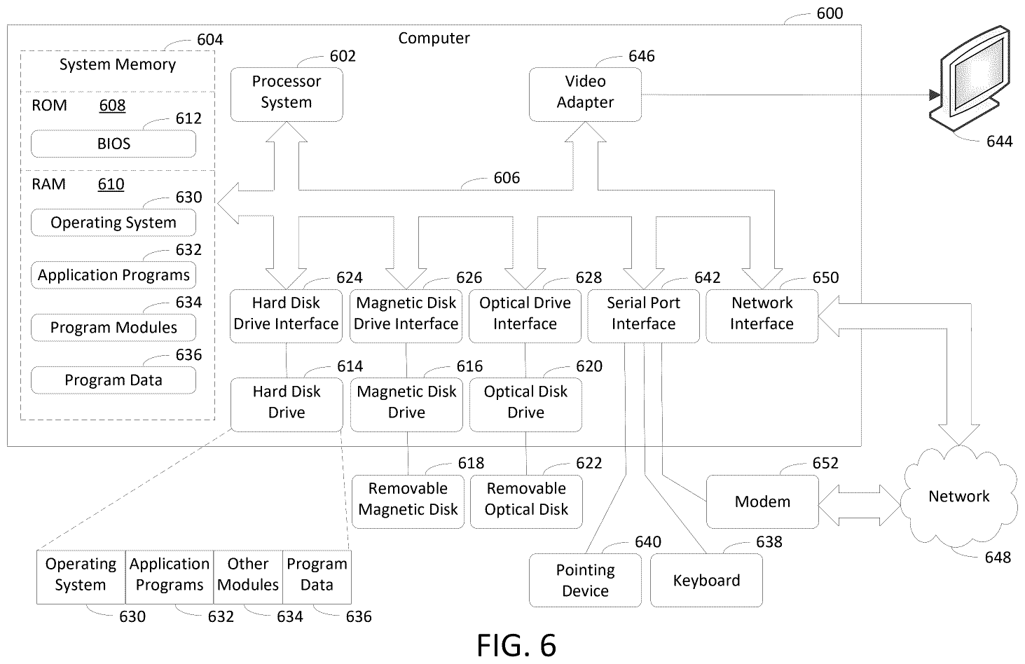

(A1) An example system (FIG. 1, 102A-102M, 106A-106N; FIG. 4, 400; FIG. 5, 502; FIG. 6, 600) comprises a processor system (FIG. 5, 510; FIG. 6, 602) and a memory (FIG. 5, 520, 522, 524; FIG. 6, 604, 608, 610) that stores computer-executable instructions. The computer-executable instructions are executable by the processor system to at least cause (FIG. 2, 232; FIG. 3, 302) a first virtual machine (FIG. 1, 122; FIG. 2, 222; FIG. 4, 422) corresponding to a first managed runtime environment (FIG. 1, 112) to load (FIG. 2, 234) bridging logic (FIG. 1, 116; FIG. 2, 216; FIG. 4, 416), which loads (FIG. 2, 236) a second virtual machine (FIG. 1, 124; FIG. 2, 224; FIG. 4, 424) corresponding to a second managed runtime environment (FIG. 1, 114), by loading the first virtual machine, wherein the first virtual machine performs the following operations: convert (FIG. 2, 246; FIG. 3, 304) a source code file (FIG. 4, 440), which is created (FIG. 2, 244) from metadata (FIG. 4, 448) associated with a file (FIG. 4, 456) in the second managed runtime environment, into a compiled file (FIG. 4, 434), which corresponds to the first managed runtime environment, by compiling the source code file; expose (FIG. 2, 248; FIG. 3, 306) the compiled file as an HTTP endpoint (FIG. 2, 226; FIG. 4, 426); execute (FIG. 3, 308) the file on the second virtual machine by passing (FIG. 2, 252) an argument (FIG. 4, 438), which is included in a call (FIG. 4, 454) from the HTTP endpoint, to the second virtual machine via the bridging logic, which causes the second virtual machine to generate (FIG. 2, 256) a result (FIG. 4, 446) by executing the file using the argument; and provide (FIG. 2, 262; FIG. 3, 310) the result, which is received from the second virtual machine via the bridging logic, to the HTTP endpoint.

(A2) In the example system of A1, wherein the first virtual machine further performs the following operations: parse the metadata to provide parsed metadata; and create the source code file using the parsed metadata.

(A3) In the example system of any of A1-A2, wherein the computer-executable instructions are executable by the processor system to at least: load the first virtual machine as a .NET application; and wherein the first managed runtime environment is a .NET environment.

(A4) In the example system of any of A1-A3, wherein the bridging logic loads the second virtual machine using a foreign function interface.

(A5) In the example system of any of A1-A4, wherein the bridging logic loads the second virtual machine using a Java native interface; and wherein the second virtual machine is a Java virtual machine.

(A6) In the example system of any of A1-A5, wherein the bridging logic loads the second virtual machine in a same address space in which the first virtual machine is loaded.

(A7) In the example system of any of A1-A6, wherein the first virtual machine retrieves the metadata from a database in which the second virtual machine stores the metadata.

(A8) In the example system of any of A1-A7, wherein the first virtual machine converts the source code file into the compiled file by mapping data types, which are associated with the second managed runtime environment, in the source code file to corresponding data types, which are associated with the first managed runtime environment, in the compiled file.

(A9) In the example system of any of A1-A8, wherein the first virtual machine converts the source code file into the compiled file by mapping functionality in the source code file to corresponding functionality in the compiled file.

(A10) In the example system of any of A1-A9, wherein the first virtual machine converts the source code file into the compiled file by wrapping the source code file in a wrapper.

(A11) In the example system of any of A1-A10, wherein the bridging logic is written in native code, which is configured to run directly on the processor system

(A12) In the example system of any of A1-A11, wherein the bridging logic enables the first virtual machine to execute the file on the second virtual machine natively.

(B1) An example method is implemented by a computing system (FIG. 1, 102A-102M, 106A-106N; FIG. 4, 400; FIG. 5, 502; FIG. 6, 600). The method comprises causing (FIG. 2, 232; FIG. 3, 302) a first virtual machine (FIG. 1, 122; FIG. 2, 222; FIG. 4, 422) corresponding to a first managed runtime environment (FIG. 1, 112) to load (FIG. 2, 234) bridging logic (FIG. 1, 116;

FIG. 2, 216; FIG. 4, 416), which loads (FIG. 2, 236) a second virtual machine (FIG. 1, 124; FIG. 2, 224; FIG. 4, 424) corresponding to a second managed runtime environment (FIG. 1, 114), by loading the first virtual machine. The method further comprises converting (FIG. 2, 246; FIG. 3, 304), by the first virtual machine, a source code file (FIG. 4, 440), which is created (FIG. 2, 244) from metadata (FIG. 4, 448) associated with a file (FIG. 4, 456) in the second managed runtime environment, into a compiled file (FIG. 4, 434), which corresponds to the first managed runtime environment, by compiling the source code file. The method further comprises exposing (FIG. 2, 248; FIG. 3, 306), by the first virtual machine, the compiled file as an HTTP endpoint (FIG. 2, 226; FIG. 4, 426). The method further comprises executing (FIG. 3, 308), by the first virtual machine, the file on the second virtual machine by passing (FIG. 2, 252) an argument (FIG. 4, 438), which is included in a call (FIG. 4, 454) from the HTTP endpoint, to the second virtual machine via the bridging logic, which causes the second virtual machine to generate (FIG. 2, 256) a result (FIG. 4, 446) by executing the file using the argument. The method further comprises providing (FIG. 2, 262; FIG. 3, 310), by the first virtual machine, the result, which is received from the second virtual machine via the bridging logic, to the HTTP endpoint.

(B2) In the example method of B1, further comprising: parsing, by the first virtual machine, the metadata to provide parsed metadata; and creating, by the first virtual machine, the source code file using the parsed metadata.

(B3) In the example method of any of B1-B2, further comprising: loading the first virtual machine as a .NET application; wherein the first managed runtime environment is a .NET environment.

(B4) In the example method of any of B1-B3, wherein the second virtual machine is loaded by the bridging logic using a foreign function interface.

(B5) In the example method of any of B1-B4, wherein the second virtual machine is loaded by the bridging logic using a Java native interface; and wherein the second virtual machine is a Java virtual machine.

(B6) In the example method of any of B1-B5, wherein the second virtual machine is loaded by the bridging logic in a same address space in which the first virtual machine is loaded.

(B7) In the example method of any of B1-B6, further comprising: retrieving, by the first virtual machine, the metadata from a database in which the second virtual machine stores the metadata.

(B8) In the example method of any of B1-B7, further comprising: converting, by the first virtual machine, the source code file into the compiled file by mapping data types, which are associated with the second managed runtime environment, in the source code file to corresponding data types, which are associated with the first managed runtime environment, in the compiled file.

(B9) In the example method of any of B1-B8, further comprising: converting, by the first virtual machine, the source code file into the compiled file by mapping functionality in the source code file to corresponding functionality in the compiled file.

(B10) In the example method of any of B1-B9, wherein converting the source code file into the compiled file comprises: wrapping the source code file in a wrapper.

(B11) In the example method of any of B1-B10, wherein the bridging logic is written in native code, which is configured to run directly on a processor system that is included in the computing system.

(B12) In the example method of any of B1-B11, wherein the bridging logic enables the first virtual machine to execute the file on the second virtual machine natively.

(C1) An example computer program product (FIG. 5, 524; FIG. 6, 618, 622) comprises a computer-readable storage medium having instructions recorded thereon for enabling a processor-based system (FIG. 1, 102A-102M, 106A-106N; FIG. 4, 400; FIG. 5, 502; FIG. 6, 600) to perform operations. The operations comprise causing (FIG. 2, 232; FIG. 3, 302) a first virtual machine (FIG. 1, 122; FIG. 2, 222; FIG. 4, 422) corresponding to a first managed runtime environment (FIG. 1, 112) to load (FIG. 2, 234) bridging logic (FIG. 1, 116; FIG. 2, 216; FIG. 4, 416), which loads (FIG. 2, 236) a second virtual machine (FIG. 1, 124; FIG. 2, 224; FIG. 4, 424) corresponding to a second managed runtime environment (FIG. 1, 114), by loading the first virtual machine. The operations further comprise converting (FIG. 2, 246; FIG. 3, 304), by the first virtual machine, a source code file (FIG. 4, 440), which is created (FIG. 2, 244) from metadata (FIG. 4, 448) associated with a file (FIG. 4, 456) in the second managed runtime environment, into a compiled file (FIG. 4, 434), which corresponds to the first managed runtime environment, by compiling the source code file. The operations further comprise exposing (FIG. 2, 248; FIG. 3, 306), by the first virtual machine, the compiled file as an HTTP endpoint (FIG. 2, 226; FIG. 4, 426). The operations further comprise executing (FIG. 3, 308), by the first virtual machine, the file on the second virtual machine by passing (FIG. 2, 252) an argument (FIG. 4, 438), which is included in a call (FIG. 4, 454) from the HTTP endpoint, to the second virtual machine via the bridging logic, which causes the second virtual machine to generate (FIG. 2, 256) a result (FIG. 4, 446) by executing the file using the argument. The operations further comprise providing (FIG. 2, 262; FIG. 3, 310), by the first virtual machine, the result, which is received from the second virtual machine via the bridging logic, to the HTTP endpoint.

### III. Example Computer System

FIG. 6 depicts an example computer 600 in which embodiments may be implemented. Any one or more of the user devices 102A-102M and/or any one or more of the servers 106A-106N shown in FIG. 1 and/or the computing system 400 shown in FIG. 4 may be implemented using computer 600, including one or more features of computer 600 and/or alternative features. Computer 600 may be a general-purpose computing device in the form of a conventional personal computer, a mobile computer, or a workstation, for example, or computer 600 may be a special purpose computing device. The description of computer 600 provided herein is provided for purposes of illustration, and is not intended to be limiting. Embodiments may be implemented in further types of computer systems, as would be known to persons skilled in the relevant art(s).

As shown in FIG. 6, computer 600 includes a processor system 602, a system memory 604, and a bus 606 that couples various system components including system memory 604 to processor system 602. Bus 606 represents one or more of any of several types of bus structures, including a memory bus or memory controller, a peripheral bus, an accelerated graphics port, and a processor or local bus using any of a variety of bus architectures. System memory 604 includes read only memory (ROM) 608 and random access memory (RAM) 610. A basic input/output system (BIOS) 612 is stored in ROM 608.

Computer 600 also has one or more of the following drives: a hard disk drive 614 for reading from and writing to a hard disk, a magnetic disk drive 616 for reading from or writing to a removable magnetic disk 618, and an optical disk drive 620 for reading from or writing to a removable optical disk 622 such as a CD ROM, DVD ROM, or other optical media. Hard disk drive 614, magnetic disk drive 616, and optical disk drive 620 are connected to bus 606 by a hard disk drive interface 624, a magnetic disk drive interface 626, and an optical drive interface 628, respectively. The drives and their associated computer-readable storage media provide nonvolatile storage of computer-readable instructions, data structures, program modules and other data for the computer. Although a hard disk, a removable magnetic disk and a removable optical disk are described, other types of computer-readable storage media can be used to store data, such as flash memory cards, digital video disks, random access memories (RAMs), read only memories (ROM), and the like.

A number of program modules may be stored on the hard disk, magnetic disk, optical disk, ROM, or RAM. These programs include an operating system 630, one or more application programs 632, other program modules 634, and program data 636. Application programs 632 or program modules 634 may include, for example, computer program logic for implementing any one or more of (e.g., at least a portion of) the hybrid runtime environment logic 108, the hybrid runtime environment logic 208, the bridging logic 216, the triggering logic 218, the first virtual machine 222, the second virtual machine 224, the HTTP endpoint 226, the hybrid runtime environment logic 408, the hybrid runtime environment logic 408, the bridging logic 416, the triggering logic 418, the first virtual machine 422, the second virtual machine 424, the HTTP endpoint 426, the daemon logic 428, the parser logic 430, the conversion logic 432, activity diagram 200 (including any activity of activity diagram 200), and/or flowchart 300 (including any step of flowchart 300), as described herein.

A user may enter commands and information into the computer 600 through input devices such as keyboard 638 and pointing device 640. Other input devices (not shown) may include a microphone, joystick, game pad, satellite dish, scanner, touch screen, camera, accelerometer, gyroscope, or the like. These and other input devices are often connected to the processor system 602 through a serial port interface 642 that is coupled to bus 606, but may be connected by other interfaces, such as a parallel port, game port, or a universal serial bus (USB).

A display device 644 (e.g., a monitor) is also connected to bus 606 via an interface, such as a video adapter 646. In addition to display device 644, computer 600 may include other peripheral output devices (not shown) such as speakers and printers.

Computer 600 is connected to a network 648 (e.g., the Internet) through a network interface (e.g., a network adapter) 650, a modem 652, or other means for establishing communications over the network. Modem 652, which may be internal or external, is connected to bus 606 via serial port interface 642.

As used herein, the terms “computer program medium” and “computer-readable storage medium” are used to generally refer to media (e.g., non-transitory media) such as the hard disk associated with hard disk drive 614, removable magnetic disk 618, removable optical disk 622, as well as other media such as flash memory cards, digital video disks, random access memories (RAMs), read only memories (ROM), and the like. A computer-readable storage medium is not a signal, such as a carrier signal or a propagating signal. For instance, a computer-readable storage medium may not include a signal. Accordingly, a computer-readable storage medium does not constitute a signal per se. Such computer-readable storage media are distinguished from and non-overlapping with communication media (do not include communication media). Communication media embodies computer-readable instructions, data structures, program modules or other data in a modulated data signal such as a carrier wave. The term “modulated data signal” means a signal that has one or more of its characteristics set or changed in such a manner as to encode information in the signal. By way of example, and not limitation, communication media includes wireless media such as acoustic, RF, infrared and other wireless media, as well as wired media. Example embodiments are also directed to such communication media.

As noted above, computer programs and modules (including application programs 632 and other program modules 634) may be stored on the hard disk, magnetic disk, optical disk, ROM, or RAM. Such computer programs may also be received via network interface 650 or serial port interface 642. Such computer programs, when executed or loaded by an application, enable computer 600 to implement features of embodiments discussed herein. Accordingly, such computer programs represent controllers of the computer 600.

Example embodiments are also directed to computer program products comprising software (e.g., computer-readable instructions) stored on any computer-useable medium. Such software, when executed in one or more data processing devices, causes data processing device(s) to operate as described herein. Embodiments may employ any computer-useable or computer-readable medium, known now or in the future. Examples of computer-readable mediums include, but are not limited to storage devices such as RAM, hard drives, floppy disks, CD ROMs, DVD ROMs, zip disks, tapes, magnetic storage devices, optical storage devices, MEMS-based storage devices, nanotechnology-based storage devices, and the like.

It will be recognized that the disclosed technologies are not limited to any particular computer or type of hardware. Certain details of suitable computers and hardware are well known and need not be set forth in detail in this disclosure.

### IV. Conclusion

The foregoing detailed description refers to the accompanying drawings that illustrate exemplary embodiments of the present invention. However, the scope of the present invention is not limited to these embodiments, but is instead defined by the appended claims. Thus, embodiments beyond those shown in the accompanying drawings, such as modified versions of the illustrated embodiments, may nevertheless be encompassed by the present invention.

References in the specification to “one embodiment,” “an embodiment,” “an example embodiment,” or the like, indicate that the embodiment described may include a particular feature, structure, or characteristic, but every embodiment may not necessarily include the particular feature, structure, or characteristic. Moreover, such phrases are not necessarily referring to the same embodiment. Furthermore, when a particular feature, structure, or characteristic is described in connection with an embodiment, it is submitted that it is within the knowledge of one skilled in the relevant art(s) to implement such feature, structure, or characteristic in connection with other embodiments whether or not explicitly described.

Descriptors such as “first”, “second”, “third”, etc. are used to reference some elements discussed herein. Such descriptors are used to facilitate the discussion of the example embodiments and do not indicate a required order of the referenced elements, unless an affirmative statement is made herein that such an order is required.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims, and other equivalent features and acts are intended to be within the scope of the claims.

What is claimed is:

1. A system comprising:
a processor system; and
a memory that stores computer-executable instructions that are executable by the processor system to at least:
cause a first virtual machine corresponding to a first managed runtime environment to load bridging logic, which loads a second virtual machine corresponding to a second managed runtime environment, by loading the first virtual machine, wherein the first virtual machine performs the following operations:
convert a source code file, which is created from metadata associated with a file in the second managed runtime environment, into a compiled file, which corresponds to the first managed runtime environment, by compiling the source code file;
expose the compiled file as an HTTP endpoint;
execute the file on the second virtual machine by passing an argument, which is included in a call from the HTTP endpoint, to the second virtual machine via the bridging logic, which causes the second virtual machine to generate a result by executing the file using the argument; and
provide the result, which is received from the second virtual machine via the bridging logic, to the HTTP endpoint.

2. The system of claim 1, wherein the first virtual machine further performs the following operations:
parse the metadata to provide parsed metadata; and
create the source code file using the parsed metadata.

3. The system of claim 1, wherein the computer-executable instructions are executable by the processor system to at least:
load the first virtual machine as a .NET application; and
wherein the first managed runtime environment is a .NET environment.

4. The system of claim 1, wherein the bridging logic loads the second virtual machine using a foreign function interface.

5. The system of claim 4, wherein the bridging logic loads the second virtual machine using a Java native interface; and
wherein the second virtual machine is a Java virtual machine.

6. The system of claim 1, wherein the bridging logic loads the second virtual machine in a same address space in which the first virtual machine is loaded.

7. The system of claim 1, wherein the first virtual machine converts the source code file into the compiled file by mapping data types, which are associated with the second managed runtime environment, in the source code file to corresponding data types, which are associated with the first managed runtime environment, in the compiled file.

8. The system of claim 1, wherein the first virtual machine converts the source code file into the compiled file by wrapping the source code file in a wrapper.

9. The system of claim 1, wherein the bridging logic enables the first virtual machine to execute the file on the second virtual machine natively.

10. A method implemented by a computing system, the method comprising:
causing a first virtual machine corresponding to a first managed runtime environment to load bridging logic, which loads a second virtual machine corresponding to a second managed runtime environment, by loading the first virtual machine;
converting, by the first virtual machine, a source code file, which is created from metadata associated with a file in the second managed runtime environment, into a compiled file, which corresponds to the first managed runtime environment, by compiling the source code file;
exposing, by the first virtual machine, the compiled file as an HTTP endpoint;
executing, by the first virtual machine, the file on the second virtual machine by passing an argument, which is included in a call from the HTTP endpoint, to the second virtual machine via the bridging logic, which causes the second virtual machine to generate a result by executing the file using the argument; and
providing, by the first virtual machine, the result, which is received from the second virtual machine via the bridging logic, to the HTTP endpoint.

11. The method of claim 10, further comprising:
parsing, by the first virtual machine, the metadata to provide parsed metadata; and
creating, by the first virtual machine, the source code file using the parsed metadata.

12. The method of claim 10, further comprising:
loading the first virtual machine as a .NET application;
wherein the first managed runtime environment is a .NET environment.

13. The method of claim 10, wherein the second virtual machine is loaded by the bridging logic using a foreign function interface.

14. The method of claim 13, wherein the second virtual machine is loaded by the bridging logic using a Java native interface; and
wherein the second virtual machine is a Java virtual machine.

15. The method of claim 10, further comprising:
retrieving, by the first virtual machine, the metadata from a database in which the second virtual machine stores the metadata.

16. The method of claim 10, further comprising:
converting, by the first virtual machine, the source code file into the compiled file by mapping functionality in the source code file to corresponding functionality in the compiled file.

17. The method of claim 10, wherein converting the source code file into the compiled file comprises:
wrapping the source code file in a wrapper.

18. The method of claim 10, wherein the bridging logic is written in native code, which is configured to run directly on a processor system that is included in the computing system.

19. The method of claim 10, wherein the bridging logic enables the first virtual machine to execute the file on the second virtual machine natively.

20. A computer program product comprising a computer-readable storage medium having instructions recorded thereon for enabling a processor-based system to perform operations, the operations comprising:
causing a first virtual machine corresponding to a first managed runtime environment to load bridging logic, which loads a second virtual machine corresponding to a second managed runtime environment, by loading the first virtual machine;
converting, by the first virtual machine, a source code file, which is created from metadata associated with a file in the second managed runtime environment, into a compiled file, which corresponds to the first managed runtime environment, by compiling the source code file;
exposing, by the first virtual machine, the compiled file as an HTTP endpoint;
executing, by the first virtual machine, the file on the second virtual machine by passing an argument, which is included in a call from the HTTP endpoint, to the second virtual machine via the bridging logic, which causes the second virtual machine to generate a result by executing the file using the argument; and
providing, by the first virtual machine, the result, which is received from the second virtual machine via the bridging logic, to the HTTP endpoint.
